(19) United States
(12) Patent Application Publication
(10) Pub. No.: US 2010/0301639 A1
(43) Pub. Date: Dec. 2, 2010

(54) Combination bed seat and commode

(76) Inventor: Renee McPheeters, Crystal River, FL (US)

Correspondence Address: DOUGLAS WM. MASSINGER;MASSINGER LAW OFFICES, 887 NE 100th St, Ocala, FL, 34479, US

(21) Appl. No.: 12/454,958

(22) Filed: May 27, 2009

(51) Int. Cl. A47C 13/00; A47C 1/00; A47C 3/00; A47C 4/04; A47C 7/54; A47C 7/62; A61G 9/00

(52) U.S. Cl. 297/118; 297/256.1; 297/217.1; 297/183.5; 297/153; 4/450

(57) ABSTRACT

A combination bed seat and commode suitable for both purposes and having multiple additional features that provide the user with safety, comfort, and convenience, the apparatus comprising in a preferred embodiment a box-like base holding a bedpan under an open seat, a door for the removal of the bedpan without the need for the user to remove himself from the apparatus, an adjustable back rest pivotably connected at a hinge joint to the base housing unit, longitudinal base stabilization means preferably but not essentially in the form of a U-shaped retractable stabilizer longitudinally disposed within the base housing unit, lateral base stabilization means preferably but not essentially in the form of a pair of flange-like stabilizers projecting from the side walls of the base housing unit, and a pair of retractable armrests to facilitate movement onto and off of the apparatus. In another embodiment, the apparatus includes a removable head rest adapted to be received on a carrying handle and a tray, storable within the backrest, for the temporary storage of articles thereon.

### FIELD OF THE INVENTION

The subject invention relates generally to portable seating devices and more particularly to a portable seating device intended for use on a bed.

### BACKGROUND OF THE INVENTION

A person who is bed-ridden such as someone suffering from illness, injury, weakness or other infirmity often finds it exceptionally difficult or impossible to sit up on the edge of the bed such as may be necessary to change clothes, take sponge baths, or to eat, for instance. This is due in part to the yielding character of the underlying mattress which, while providing comfort, does so at the expense of stability of objects disposed upon it. The problem is compounded when the bed-ridden individual requires the use of a bedpan because it can be difficult for the individual to elevate his or her torso a height above the bed to properly position the bedpan for use. More often than not, the individual is without the benefit of any surrounding objects to grasp for leverage, for balance and to assist in achieving the required elevation. Instead, the individual can only place their hands on the mattress. Moreover, when placed between the individual and the bed, bedpans can cause discomfort and greater instability.

Whether a result of an unstable resting surface or an individual's own physical weakness and/or lack of balance, or all of the above, a bed-ridden individual often requires the assistance of another person such as a caregiver to help provide support and balance when seated at the edge of a bed to prevent falls. During bedpan use, however, having a caregiver provide assistance may not be desirable for those who, like most, are modest and prefer privacy. It would be ideal if there existed a portable and lightweight seat suitable for safe use on a non-rigid surface such as a bed and having a removable bedpan and other means of affording the user with comfort, support and convenience.

The prior art contains many types of portable chairs and toilets. The following U.S. utility and design patents relating to such apparatus, as well as those from which a claim for benefit of priority has been made, are incorporated herein by reference to the extent they are not inconsistent with the explicit teachings of this specification: U.S. Design Pat. No. D494,770 issued Aug. 24, 2004 to Hillard for an Inflatable Stadium or Bleacher Seat; U.S. Pat. No. 6,206,463 issued on Mar. 27, 2001 to Whigham for a Combined Carrying Case and Folding Seat; U.S. Pat. No. 6,068,342 issued on May 30, 2000 to Mariani et al. for a Recreational Furniture Containing Modified Head Portion; U.S. Pat. No. 4,781,413 issued on Nov. 1, 1988 to Shumack, Jr. for a Portable Stadium Seat; U.S. Pat. No. 4,437,195 issued on Mar. 20, 1984 to Mangels for a Self-Inflating Bed Pan; U.S. Pat. No. 4,358,125 issued on Nov. 9, 1982 to Charles for a Wheelchair Frame Construction; U.S. Pat. No. 3,092,224 issued on Jun. 4, 1963 to B. D. O'Neil for a Combined Carrying Bag and Seat; U.S. Pat. No. 2,073,390 issued on Mar. 9, 1937 to C. T. Giblette for a Toilet; and U.S. Pat. No. 1,650,365 issued on Nov. 22, 1927 to Leah Kuhn for a Portable Toilet for Infants.

None of these references are specifically adapted for use on a mattress nor do they alone or in combination possess each of the features of the instant invention. Certainly there is a need for a means of preserving the individual's dignity while simultaneously affording assistance by way of support and balance while seated at bedside.

### SUMMARY OF THE INVENTION

The subject invention meets the heretofore described needs in the art by providing a combination bed seat and commode suitable for both purposes and having multiple additional features that provide the user with safety, comfort, and convenience, the apparatus comprising in a preferred embodiment a box-like base holding a bedpan under an open seat, a door for the removal of the bedpan without the need for the user to remove himself from the apparatus, an adjustable back rest pivotably connected at a hinge joint to the base housing unit, longitudinal base stabilization means preferably but not essentially in the form of a U-shaped retractable stabilizer longitudinally disposed within the base housing unit, lateral base stabilization means preferably but not essentially in the form of a pair of flange-like stabilizers projecting from the side walls of the base housing unit, and a pair of retractable armrests to facilitate movement onto and off of the apparatus. In another embodiment, the apparatus includes a removable head rest adapted to be received on a carrying handle and a tray, storable within the backrest, for the temporary storage of articles thereon.

In use, the subject combination bed seat and commode provides a means for a user to assume seated position without leaving the bed for purposes of resting in an upright position as sometime desirable and for elimination of waste as frequently necessary, both in a supported and balanced fashion thus mitigating the risk of injury and the need for assistance by a caretaker. The subject apparatus affords the user with greater privacy thereby sparing offense to his or her dignity during private moments.

The removable bed pan as well as the apparatus as a whole may also be easily removed from the patient room for cleaning and disinfecting.

There has thus been outlined, rather broadly, the more important components and features of the invention in order that the detailed description thereof that follows may be better understood, and in order that the present contribution to the art may be better appreciated. There are, of course, additional features of the invention that will be described hereinafter and which will form the subject matter of the claims appended hereto. In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting. As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

Further, the purpose of the foregoing abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The abstract is neither intended to define the invention of the application, which is measured by the claims, nor is it intended to be limiting as to the scope of the invention in any way.

It is, therefore, a primary object of the subject invention to provide a combination bed seat and commode, the apparatus being satisfactory for both its purposes when disposed upon a bed.

It is another primary object of the subject invention to provide a combination bed seat and commode that is fabricated from materials that are durable, corrosion-resistant, and non-absorbent.

Another object of the subject invention is to provide a combination bed seat and commode that is fabricated from materials that are sufficient in weight and thickness to withstand repeated washing.

Another object of the subject invention is to provide a combination bed seat and commode that is fabricated from materials that may be finished to possess a smooth, easily cleanable surface.

Still another object of the subject invention is to provide a bed combination bed seat and commode that is fabricated from materials that are resistant to pitting, chipping, crazing, scratching, scoring, distortion and decomposition.

It is also an object of the subject invention is to provide a combination bed seat and commode that is constructed to be free of breaks, open seams, cracks, chips, inclusions, pits, and similar imperfections.

Still another object of the subject invention is to provide a combination bed seat and commode that is free of sharp internal angles, corners, and crevices which could retain moisture, bacteria, molds and other deleterious substances.

An additional object of the subject invention is to provide a combination bed seat and commode that is accessible and transportable for cleaning and inspection without being disassembled.

Another object of the subject invention is to provide a combination bed seat and commode that is relatively simple in design and therefore capable of rapid construction at relatively low costs.

These together with other objects of the invention, along with the various features of novelty which characterize the invention, are pointed out with particularity in the claims annexed to and forming a part of this disclosure. For a better understanding of the invention, its advantages and the specific objects attained by its uses, reference should be had to the accompanying drawings and descriptive matter in which there is illustrated a preferred embodiment of the invention.

### BRIEF DESCRIPTION OF THE DRAWINGS

The invention will be better understood and objects other than those set forth above will become apparent when consideration is given to the following detailed description thereof. Such description makes reference to the annexed drawings wherein:

FIG. 1 is a perspective view of the subject combination bed seat and commode shown in its operable configuration; and

FIG. 2 is a side view of the invention of FIG. 1 shown in its storage configuration.

### DETAILED DESCRIPTION OF THE PREFERRED EMBODIMENT

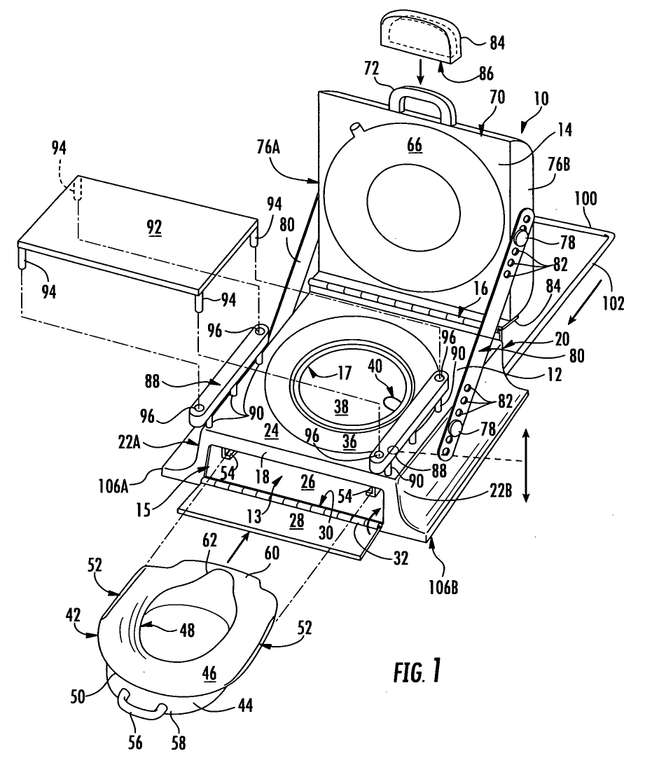

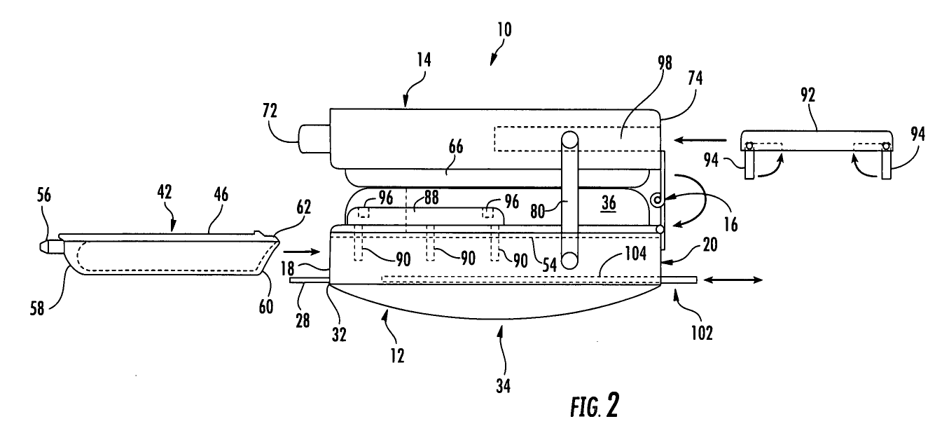

Reference is now made to FIGS. 1 and 2 in which there is illustrated perspective and side views, respectively, of the subject combination bed seat and commode (hereinafter sometimes also referred to as simply “bed seat”), designated generally by reference numeral 10. The subject invention has two primary components, namely base 12 and a backrest 14. Backrest 14 is pivotally attached to base 12 via first hinge 16 to permit folding of the apparatus into a compact storage configuration (FIG. 2).

Base 12 is a box-like structure having a chamber 13 defined by front wall 18, rear wall 20, side walls 22A and 22B, top panel 24 and bottom panel 26. Base 12 includes a first opening 15 disposed through front wall 18 and in communication with chamber 13. A door 28 is pivotally attached to front edge 30 of bottom panel 26 via second hinge 32 for selectively permitting access to chamber 13 from the surrounding environment. Bottom panel 26 has an exterior surface 34 that is convex or “dome-shaped” to facilitate movement of bed seat 10 over a mattress surface for the purpose of positioning the apparatus at the desired location. The dome-shaped exterior surface 34 acts to “lift” the apparatus from the mattress surface so that its perimeter edges do not get snagged on linens, covers and the like.

Base 12 further includes a second opening 17 disposed through top panel 24 and in communication with chamber 13. Second opening 17 is preferably but not essentially oval or egg-shaped, and is positioned such that its longest diameter extends from front to back of base 12.

A seat cushion 36 is fixedly attached to top panel 24 around second opening 17 using suitable attachment means such as an adhesive, hook and loop tape or the like. Seat cushion 36 is comprised of an inflatable tube, memory foam or other suitable material chosen for its durability, comfort, resiliency and cleanability. A lid 38 sized to fit in cooperating engagement with opening 17 selectively seals chamber 13 from access there through and serves as additional seating surface. Lid 38 may be padded to add cushion and elevation and may be wrapped in vinyl or any other cleanable covering material. A notch or aperture 40 is provided to facilitate the lid's removal.

First opening 15 is sized to receive there through bedpan 42 which is stored within chamber 13. Bedpan 42 may be of conventional construction, but preferably is comprised of a vessel or “pan” 44 having a splash proof rim 46. Rim 46 has an inner perimeter 48 sized to correspond with first opening 15 of base 12, and an outer perimeter 50 having parallel flanged side edges 52 sized and shaped for slidable engagement between a pair of opposing brackets 54 mounted to the bottom of top panel 24. Bedpan 42 further includes a handle 56 mounted to the proximal end 58 of vessel 44 to facilitate removal from chamber 13. The distal end 60 of bedpan 42 is adapted with a funnel 62 to facilitate emptying of waste. Bedpan 42 is sized to fit within chamber 13 of base 12 with door 28 in the closed position.

Backrest 14 has a generally planar shape and includes a back supporting surface 64 to which is mounted a back cushion 66, an outer surface 68 opposite back supporting surface 64, a front wall 70 having a U-shaped handle 72 attached thereto, a rear wall 74 opposite the front wall, and a pair of opposing side walls 76A,B disposed between the front and rear walls in perpendicular fashion. Like seat cushion 36, back cushion 66 is comprised of an inflatable tube, memory foam or other suitable material chosen for its durability, comfort, resiliency and cleanability, and may be mounted using a variety of mounting means.

The degree to which backrest 14 is permitted to rotate about hinge 16 is controlled using backrest adjustment means. In one embodiment, mounting pins 78 are fixedly attached to each side wall 22A,B and 76A,B and serve as anchors upon which adjustment straps 80 are mounted. A plurality of incrementally spaced holes 82 are disposed through each strap for receiving mounting pins 78 there through in a manner well known in the art between base 12 and backrest 14 to limit the degree of travel of these components relative to one another. Alternative backrest adjustment means are also contemplated such as using length adjustable straps or brackets, or adapting first hinge 16 with ratcheting means to releasably lock backrest 14 in a desired position.

In order to impart additional comfort to the subject bed seat 10, a removable cushioned headrest 84 is mountable to handle 72. Headrest 84 includes a hollow area 86 sized to fit in frictional engagement around handle 72 for mounting purposes.

Moreover, a pair of armrests 88 is height adjustably mounted to top panel 24 via a plurality of stanchions 90 slidably received within base 12. In addition to providing support for the user of the apparatus, armrests 88 serve as grab bars to help the user maintain balance while mounting the seat.

Bed seat 10 may also be equipped with a removable tray 92 upon which various items may be placed when the subject apparatus is being used as a seat, rather than as a commode. Tray 92 includes four fold down legs 94 which, when in their extended operable position (FIG. 1) are inserted into detents 96 located in the top surface of each armrest 88 for temporary mounting of the tray onto base 12. Tray 92 may be stowed in backrest 14 by first folding legs 94 to their retracted stowage position (FIG. 2) and inserting tray into storage slot 98 located within backrest 14. Slot 98 is sized and shaped to receive tray 14 snugly in place.

An important feature of bed seat 10 is its stability when disposed upon a mattress or other non-rigid surface. To accomplish stability in the longitudinal direction, that is, to prevent bed seat 10 from toppling over backwards, longitudinal stabilization means are provided. In a preferred embodiment, longitudinal stabilization means are comprised of a retractable stabilizer 100, preferably U-shaped and slidably received within base 12 in substantially co-planar relationship with bottom panel 26. When in its operable position (FIG. 1), stabilizer 100 extends from base 12 normal to rear wall 20 a distance substantially equal to the front-to-back length of base 12. Each arm 102 of stabilizer 100 may be slidably received within channels 104 which are integrally formed in side walls 22A,B (FIG. 2) or alternatively in bottom panel 26.

Bed seat 10 is further stabilized on non-rigid surfaces via lateral stabilization means which, in a first embodiment, is comprised of first and second flanges 106A,B each of which projects outwardly from side walls 22A,B, respectively, and extends from front wall 18 to rear wall 20 in substantially co-planar relationship with bottom panel 26. Flanges 106A,B are preferably tapered into side walls 22A,B to impart greater strength. The distance which flanges 106A,B extend from base 12 may vary; the further they extend, the greater the stability. Six to ten inches is optimal. In an alternate embodiment (not shown), lateral stabilization of bed seat 10 may be achieved by using retractable stabilizers, similar to stabilizer 100, which project normal to side walls 22A,B 20 in substantially co-planar relationship with bottom panel 26. Such an embodiment would include receiving channels formed in bottom panel 26, for instance.

Given that the subject bed seat 10 is also usable as a commode, it is likely that waste will come into direct contact with not only bedpan 42, but other surfaces as well. When it comes to keeping surfaces sanitary, non-porosity is key. Using porous materials that can absorb water and subsequently hold onto it increases the chances of cross-contamination from growing bacteria. Moreover, because the surfaces of the subject apparatus will be exposed to waste and will require frequent cleaning, said surfaces shall be constructed of a corrosion-resistant, nonabsorbent, and smooth material. Such materials may not allow the migration of deleterious substances and under normal use conditions shall be: safe; durable, corrosion-resistant, and nonabsorbent; sufficient in weight and thickness to withstand repeated washing; finished to have a smooth, easily cleanable surface; and resistant to pitting, chipping, crazing, scratching, scoring, distortion, and decomposition. Particularly when employed in a hospital setting the subject apparatus is preferably constructed to be free of breaks, open seams, cracks, chips, inclusions, pits, and similar imperfections; free of sharp internal angles, corners, and crevices; finished to have smooth welds and joints; and accessible for cleaning and inspection without being disassembled. For this purpose, it is contemplated that top panel 24 of base 12 may be hingedly attached to rear wall 20 such that it may be lifted up to provide access to chamber 13 for cleaning purposes.

Other than the cushions of the subject apparatus, its components may be fabricated, for example, from high density polyethylene, a clean, white, high-impact plastic material that is almost unbreakable. As an alternative, such components may be fabricated from polypropylene to exhibit very high corrosion-resistance to acidic, alkaline and saline solutions. In this embodiment, the apparatus is satisfactory for service at temperatures up to 250° F. and can be sterilized. The polypropylene construction has high tensile strength and tremendous impact strength and very importantly has virtually no water absorption. This material may be used to create a special “skid-proof” textured surface to resist sliding of contained material. Another viable alternative is to fabricate the apparatus from fiberglass which will provide a smooth surface with rounded corners for easy cleaning. Sturdy fiberglass won't dent, chip, bend, peel, crack or warp. Fiberglass is suitable for color coding of the apparatus and are impervious to dishwasher temperatures and detergents and resistant to industrial cleaners. It will withstand continuous service from −40° F. to 250° F. with intermittent service as high as 300° F. Other suitable materials may also be employed. Bedpan 42 may also be constructed of stainless steel.

Although the present invention has been described with reference to the particular embodiments herein set forth, it is understood that the present disclosure has been made only by way of example and that numerous changes in details of construction may be resorted to without departing from the spirit and scope of the invention. Thus, the scope of the invention should not be limited by the foregoing specifications, but rather only by the scope of the claims appended hereto.

What is claimed as being new, useful and desired to be protected by Letters Patent of the United States is as follows:

1. A portable bed seat, comprising:
a. a backrest pivotally attached to a base comprised of a front wall and a rear wall disposed between opposing side walls, a top panel and a bottom panel;
b. means for adjusting the degree of rotation of said backrest relative to said base;
c. longitudinal stabilization means slidably received within said base in substantially co-planar relationship with said bottom panel; and
d. lateral stabilization means comprised of first and second flanges which project outwardly from said opposing side walls in substantially co-planar relationship with said bottom panel.

2. A portable bed seat, comprising:
a. a backrest pivotally attached to a base comprised of a front wall and a rear wall disposed between opposing side walls, a top panel and a bottom panel together said front wall, rear wall, side walls, top panel and bottom panel forming a chamber sized to receive a bedpan;
b. means for adjusting the degree of rotation of said backrest relative to said base;
c. longitudinal stabilization means slidably received within said base in substantially co-planar relationship with said bottom panel;
d. lateral stabilization means comprised of first and second flanges which project outwardly from said opposing side walls in substantially co-planar relationship with said bottom panel;
e. a first opening in said front wall, in communication with said chamber, and sized to receive there through a bedpan;
f. a second opening in said top panel and in communication with said chamber; and
g. a seat cushion removably attached to said top panel and around said second opening.

3. The portable bed seat of claim 1 wherein said bottom panel has a convex exterior surface.

4. The portable bed seat of claim 2 wherein said bottom panel has a convex exterior surface.

5. The portable bed seat of claim 2 further including a lid sized to fit in cooperative engagement with said second opening.

6. The portable bed seat of claim 3 further including a lid sized to fit in cooperative engagement with said second opening.

7. The portable bed seat of claim 4 further including a lid sized to fit in cooperative engagement with said second opening.

8. The portable bed seat of claim 1 further including handle attached to said backrest and a headrest having a hollow area sized to fit in frictional engagement around said handle.

9. The portable bed seat of claim 2 further including handle attached to said backrest and a headrest having a hollow area sized to fit in frictional engagement around said handle.

10. The portable bed seat of claim 1 further including a pair of armrests height adjustably mounted to said top panel via a plurality of stanchions slidably received within said base.

11. The portable bed seat of claim 2 further including a pair of armrests height adjustably mounted to said top panel via a plurality of stanchions slidably received within said base.

12. The portable bed seat of claim 3 further including a pair of armrests height adjustably mounted to said top panel via a plurality of stanchions slidably received within said base.

13. The portable bed seat of claim 4 further including a pair of armrests height adjustably mounted to said top panel via a plurality of stanchions slidably received within said base.

14. The portable bed seat of claim 10 wherein said backrest includes a storage slot sized and shaped to receive a serving tray therein, said serving tray including at least four support legs; and wherein each of said armrests includes at least two detents sized and shaped to receive therein one of said four legs of said serving tray, whereby said serving tray is supported on said pair of armrests above said base.

15. The portable bed seat of claim 11 wherein said backrest includes a storage slot sized and shaped to receive a serving tray therein, said serving tray including at least four support legs; and wherein each of said armrests includes at least two detents sized and shaped to receive therein one of said four legs of said serving tray, whereby said serving tray is supported on said pair of armrests above said base.

16. The portable bed seat of claim 12 wherein said backrest includes a storage slot sized and shaped to receive a serving tray therein, said serving tray including at least four support legs; and wherein each of said armrests includes at least two detents sized and shaped to receive therein one of said four legs of said serving tray, whereby said serving tray is supported on said pair of armrests above said base.

17. The portable bed seat of claim 13 wherein said backrest includes a storage slot sized and shaped to receive a serving tray therein, said serving tray including at least four support legs; and wherein each of said armrests includes at least two detents sized and shaped to receive therein one of said four legs of said serving tray, whereby said serving tray is supported on said pair of armrests above said base.
